(19) United States
(12) Patent Application Publication
(10) Pub. No.: US 2021/0005908 A1
(43) Pub. Date: Jan. 7, 2021

(54) FUEL CELL SYSTEM

(71) Applicant: HONDA MOTOR CO., LTD., Tokyo (JP)

(72) Inventors: Ryoichi Yoshitomi, Wako-shi (JP); Hitoshi Horio, Wako-shi (JP)

(21) Appl. No.: 16/914,672

(22) Filed: Jun. 29, 2020

(30) Foreign Application Priority Data
Jul. 3, 2019 (JP) 2019-124385

(51) Int. Cl. H01M 8/04858; H01M 8/2465; B60L 58/30

(52) U.S. Cl. CPC H01M 8/0488; H01M 2250/20; B60L 58/30; H01M 8/2465

(57) ABSTRACT

In a fuel cell system, a voltage controller provided on a lateral side of a fuel cell stack and a contactor provided above the fuel cell stack are electrically connected together by bus bars in the form of flat plates. The bus bars are each provided with a displacement absorption structure which enables the voltage controller and the contactor to be displaced closer to each other in a direction in which the fuel cell stack and the voltage controller are arranged.

### CROSS-REFERENCE TO RELATED APPLICATION

This application is based upon and claims the benefit of priority from Japanese Patent Application No. 2019-124385 filed on Jul. 3, 2019, the contents of which are incorporated herein by reference.

### BACKGROUND OF THE INVENTION

### Field of the Invention

The present invention relates to a fuel cell system.

### Description of the Related Art

For example, Japanese Laid-Open Patent Publication No. 2018-060772 discloses a fuel cell system in which a bus bar electrically connected to an electrode terminal of a fuel cell stack is provided with a spring mechanism.

### SUMMARY OF THE INVENTION

In the fuel cell system, there is a case where a first electrical equipment auxiliary device provided on a lateral side of the fuel cell stack and a second electrical equipment auxiliary device provided above the fuel cell stack are electrically connected together by a bus bar in the form of a flat plate. For example, when collision occurs in a vehicle equipped with the fuel cell system, an external load (impact load) in a direction from the first electrical equipment auxiliary device toward the fuel cell stack may be applied to the first electrical equipment auxiliary device. In such a case, the external load applied to the first electrical equipment auxiliary device is applied to the second electrical equipment auxiliary device through the bus bar. Japanese Laid-Open Patent Publication No. 2018-060772 does not include any description regarding such structure and problems.

The present invention has been made taking such a problems into consideration, and an object of the present invention is to provide a fuel cell system which makes it possible to reduce application of an external load from a bus bar to a second electrical equipment auxiliary device.

According to an aspect of the present invention, provided is a fuel cell system in which a first electrical equipment auxiliary device provided on a lateral side of a fuel cell stack and a second electrical equipment auxiliary device provided above the fuel cell stack are electrically connected together by a bus bar in a form of a flat plate, wherein the bus bar is provided with a displacement absorption structure which enables the first electrical equipment auxiliary device and the second electrical equipment auxiliary device to be displaced closer to each other in a direction in which the fuel cell stack and the first electrical equipment auxiliary device are arranged.

According to the present invention, even if the external load in the direction from the first electrical equipment auxiliary device to the fuel cell stack is applied to the first electrical equipment auxiliary device, since the first electrical equipment auxiliary device and the second electrical equipment auxiliary device are displaced in the direction closer to the each other by the displacement absorption structure of the bus bar, it is possible to reduce application of the external load from the bus bar to the second electrical equipment auxiliary device.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view schematically showing a fuel cell vehicle equipped with a fuel cell system according to an embodiment of the present invention, viewed from the vehicle front side of the fuel cell vehicle;

FIG. 2 is a diagram schematically showing structure of an electric system of the fuel cell vehicle in FIG. 1;

FIG. 3 is a cross sectional view with partial omission taken along a horizontal direction of the fuel cell system in FIG. 1;

FIG. 4 is a vertical cross sectional view with partial omission taken along a line IV-IV in FIG. 3;

FIG. 5 is an exploded perspective view showing a third power line and a fourth power line;

FIG. 6 is a cross sectional view showing movement of a bus bar at the time of collision of the fuel cell vehicle;

FIG. 7A is a perspective view with partial omission showing a first bus bar according to a first modified embodiment;

FIG. 7B is a perspective view with partial omission showing a first bus bar according to a second modified embodiment; and

FIG. 8 is a view showing a modified example of each of a third power line and a fourth power line.

### DESCRIPTION OF THE PREFERRED EMBODIMENTS

Hereinafter, preferred embodiments of a fuel cell system according to the present invention will be described with reference to the accompanying drawings.

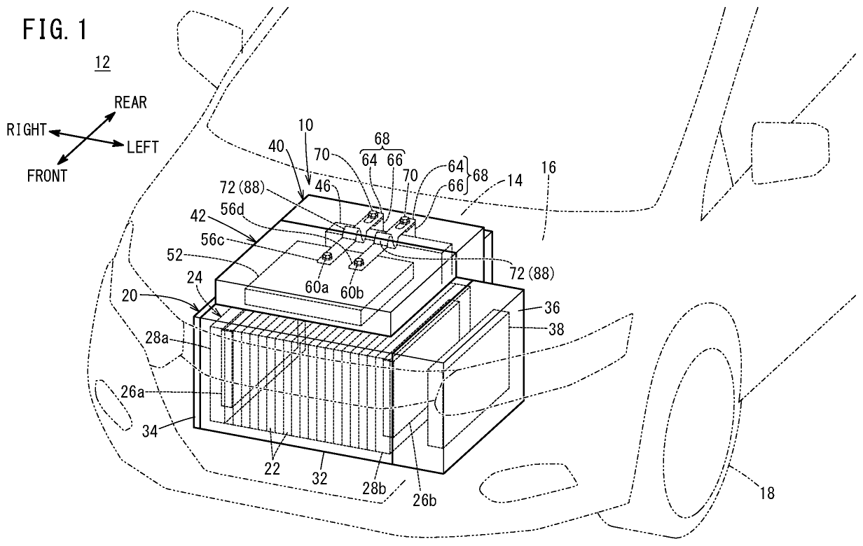

As shown in FIG. 1, a fuel cell vehicle 12 according to an embodiment of the present invention includes a fuel cell system 10 mounted in a front box 16 (motor room) formed on the vehicle front side of a dashboard 14. The front box 16 is positioned adjacent to front wheels 18.

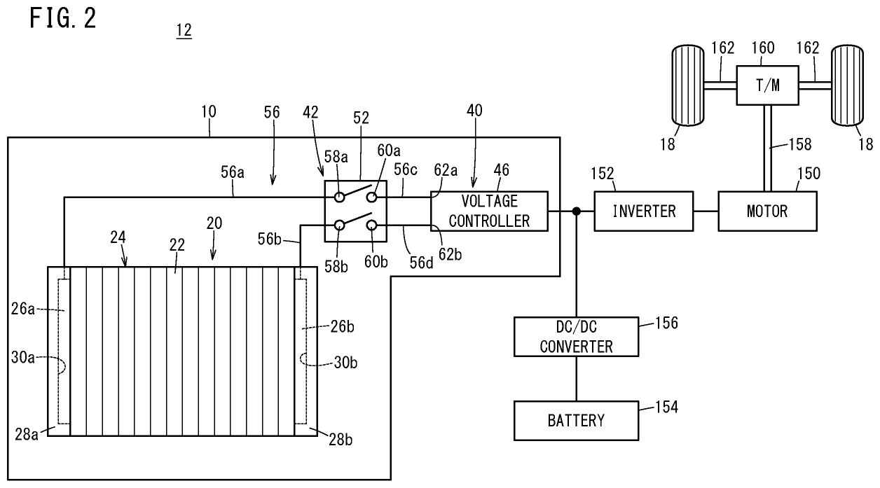

In FIG. 2, the fuel cell vehicle 12 includes a traction motor 150, an inverter 152, a battery 154 as an energy storage device, and a DC/DC converter 156. The motor 150 generates a driving force based on electrical energy supplied from the fuel cell system 10 and the battery 154. By the driving force, the front wheels 18 as drive wheels are rotated through a power transmission unit 158, a transmission (T/M) 160 and an axle 162. Further, the motor 150 outputs the electrical energy generated by regeneration, to the battery 154.

The inverter 152 performs direct current/alternating current conversion to convert the direct current into the three phase alternating current, and supplies the alternating current to the motor 150. Further, the inverter 152 supplies the direct current after alternating current/direct current conversion as a result of regenerative operation of the motor 150, to the battery 154 through the DC/DC converter 156.

As shown in FIGS. 1 and 2, the fuel cell system 10 includes a fuel cell stack 20. The fuel cell stack 20 includes a stack body 24 formed by stacking a plurality of power generation cells 22 in a horizontal direction (vehicle left/right direction). At one end of the stack body 24 in the stacking direction (end on the vehicle right side), a terminal plate 26a is provided, and an insulator 28a is provided outside the terminal plate 26a.

At the other end of the stack body 24 in the stacking direction (end on the vehicle left side), a terminal plate 26b is provided, and an insulator 28b is provided outside the terminal plate 26b. The terminal plate 26a is disposed in a recess 30a formed in a surface of the insulator 28a facing the stack body 24. The terminal plate 26b is disposed in a recess 30b formed in a surface of the insulator 28b facing the stack body 24.

In FIG. 1, the stack body 24 is placed in a stack case 32. The stack case 32 has a quadrangular tubular shape, and covers the stack body 24 from a direction perpendicular to the stacking direction. An end plate 34 is fastened to one end of the stack case 32 (end on the vehicle right side) using a plurality of bolts (not shown). The end plate 34 applies a tightening load to the stack body 24 in the stacking direction.

An auxiliary device case 36 is provided at the other end of the stack case 32 (end on the vehicle left side). The auxiliary device case 36 is a protection case for protecting fuel cell auxiliary devices 38. A fuel gas system device and an oxygen-containing gas system device are placed as the fuel cell auxiliary devices 38 in the auxiliary device case 36.

The power generation cells 22 perform power generation by electrochemical reactions of a fuel gas (e.g., a hydrogen gas) and an oxygen-containing gas (e.g., the air). Although not shown in detail, each of the power generation cells 22 includes a membrane electrode assembly, and a pair of separators sandwiching the membrane electrode assembly from both sides. The membrane electrode assembly includes an electrolyte membrane, and a cathode and an anode provided on both sides of the electrolyte membrane. The electrolyte membrane is an ion exchange membrane.

In FIGS. 1, 3, and 4, the fuel cell system 10 includes a voltage control unit 40 (VCU) disposed on a lateral side (vehicle rear side) of the fuel cell stack 20, and a contactor unit 42 disposed above the fuel cell stack 20. The voltage control unit 40 and the contactor unit 42 are provided adjacent to each other in the vehicle front/rear direction.

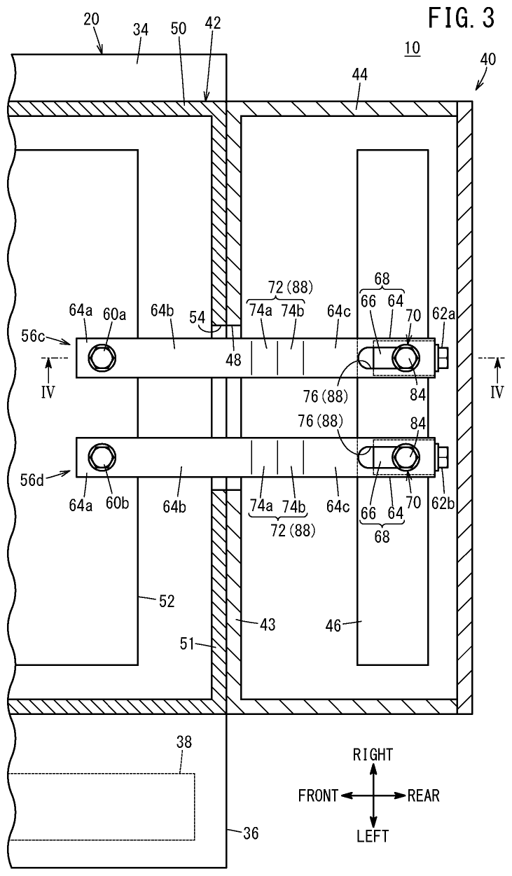

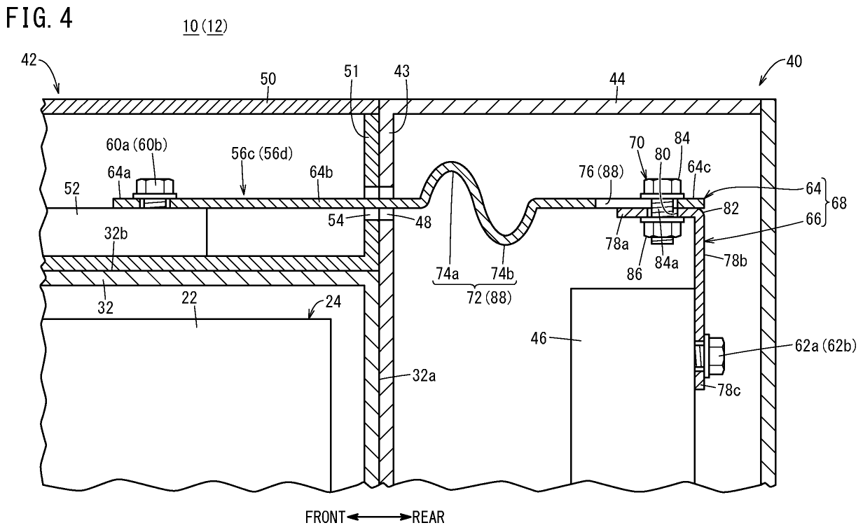

As shown in FIGS. 3 and 4, the voltage control unit 40 includes a box-shaped control case 44, and a voltage controller 46 (first electrical equipment auxiliary device) placed in the control case 44. The control case 44 is fixed to a rear surface 32a of the stack case 32 using bolts (not shown), etc. The control case 44 protrudes above the stack case 32. That is, the upper part of the control case 44 faces the contactor unit 42. A through hole 48 is formed in the upper part of a front wall 43 of the control case 44.

The voltage controller 46 is a step-up DC/DC converter for boosting the voltage of the electrical energy supplied from the fuel cell stack 20. The voltage controller 46 controls electrical current by controlling the secondary voltage (voltage on the output side), to change the output voltage of the fuel cell stack 20.

As shown in FIGS. 3 and 4, the contactor unit 42 includes a contactor case 50 which is a switch box, and disposed on an upper surface 32b of the stack case 32, and a contactor 52 (second electrical equipment auxiliary device, a switch) placed in the contactor case 50. A through hole 54, which is connected to the through hole 48 of the control case 44, is formed in a rear wall 51 of the contactor case 50.

In FIG. 2, the contactor 52 turns on/off a power line 56 which connects the fuel cell stack 20 and the voltage controller 46 together. As long as the contactor 52 can turn on/off the electrical current between the fuel cell stack 20 and the DC/DC converter 156, the shape of the contactor 52 is not limited. The contactor 52 may be a semiconductor switch. Further, the contactor 52 may be an interruption switch (fuse, etc.) for interrupting the power line 56.

Specifically, the contactor 52 includes a first input terminal 58a, a second input terminal 58b, a first output terminal 60a, and a second output terminal 60b. The first input terminal 58a is electrically connected to the terminal plate 26a through a first power line 56a. The second input terminal 58b is electrically connected to the terminal plate 26b through a second power line 56b.

The first output terminal 60a is electrically connected to a first input terminal 62a of the voltage controller 46 through a third power line 56c. The second output terminal 60b is electrically connected to a second input terminal 62b of the voltage controller 46 through a fourth power line 56d.

As shown in FIGS. 3 to 5, the third power line 56c includes a bus bar 68 in the form of a flat plate including a first bus bar 64 and a second bus bar 66, and a joint portion 70 which joins the first bus bar 64 and the second bus bar 66 together. The joint portion 70 electrically connects the first bus bar 64 and the second bus bar 66 together (connects the first bus bar 64 and the second bus bar 66 in the state where the electrical current flows through the first bus bar 64 and the second bus bar 66). The first bus bar 64 and the second bus bar 66 are band-shaped metal plates. Examples of materials of the first bus bar 64 and the second bus bar 66 include copper, copper alloy, aluminum, aluminum alloy, etc.

The first bus bar 64 includes one end 64a to which the first output terminal 60a of the contactor 52 is electrically connected, a first extension 64b extending from the one end 64a toward the vehicle rear side, and another end 64c joined to the second bus bar 66 by the joint portion 70. The first extension 64b extends in the direction (vehicle front/rear direction) in which the fuel cell stack 20 and the voltage controller 46 are arranged, so as to penetrate through the through holes 48, 54. That is, one end of the first extension 64b is positioned inside the contactor case 50. The other end of the first extension 64b is positioned inside the control case 44.

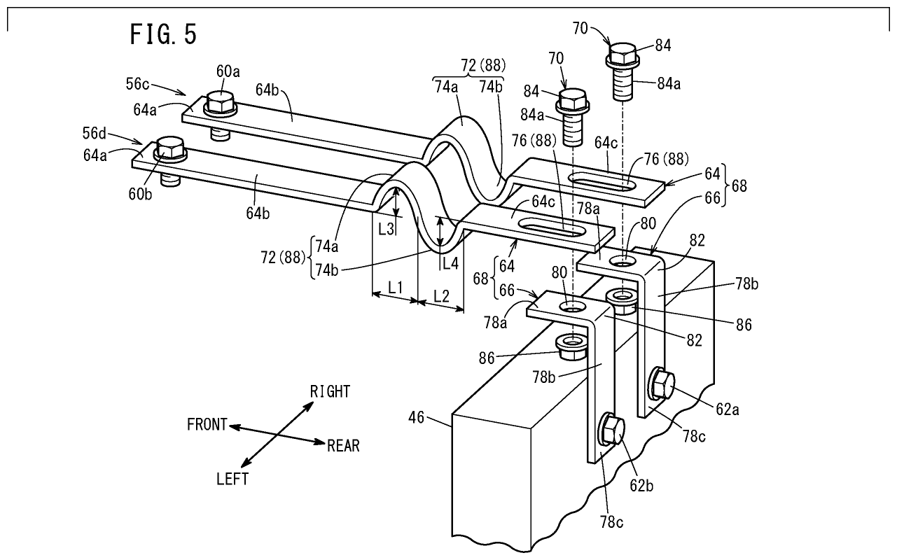

The first extension 64b includes a non-straight portion 72 which enables the bus bas 68 to be elastically deformed in the vehicle front/rear direction. The non-straight portion 72 is positioned inside the control case 44. It should be noted that the non-straight portion 72 may be positioned inside the contactor case 50. The non-straight portion 72 is in the form of a spring and includes a first curved portion 74a curved toward one surface of the first extension 64b (upward), and a second curved portion 74b curved toward the other surface of the first extension 64b (downward). Each of the first curved portion 74a and the second curved portion 74b extends over the entire width of the first bus bar 64 (see FIGS. 3 and 5).

In FIGS. 4 and 5, the first curved portion 74a has a circular arc shape (e.g., semicircular shape), and is curved to protrude upward. The second curved portion 74b has a circular arc shape (e.g., semicircular shape), and is curved to protrude downward. That is, the second curved portion 74b has a shape formed by inverting the first curved portion 74a upside down. The first curved portion 74a and the second curved portion 74b are continuous with each other.

As shown in FIG. 5, in the normal state where an external load P (impact load) is not applied to the fuel cell system 10, a length L1 of the first curved portion 74a in the vehicle front/rear direction is the same as a length L2 of the second curved portion 74b in the vehicle front/rear direction. It should be noted that the length L1 may be larger than or smaller than the length L2. An upward protruding length L3 of the first curved portion 74a protruding from the first extension 64b is the same as a downward protruding length L4 of the second curved portion 74b protruding from the first extension 64b. It should be noted that the protruding length L3 may be larger than or smaller than the protruding length L4.

In FIGS. 3 to 5, a first insertion hole 76 is formed in the other end 64c (end on the vehicle rear side) of the first bus bar 64. The first insertion hole 76 is a long hole extending in the direction in which the first bus bar 64 extends (direction in which the fuel cell stack 20 and the voltage controller 46 are arranged). The first bus bar 64 has a constant lateral cross sectional area over the entire length. That is, the non-straight portion 72 has a shape by which the non-straight portion 72 can exhibit spring property without any change in the lateral cross sectional area of the first bus bar 64. It should be noted that, in the first bus bar 64, the lateral cross sectional area of the non-straight portion 72 may be smaller than the lateral cross sectional area of the other portion (first extension 64b, for example). In this case, the non-straight portion 72 can be curved easily.

As shown in FIGS. 4 and 5, the second bus bar 66 includes one end 78a joined to the first bus bar 64 by the joint portion 70, a second extension 78b extending downward from the one end 78a, and another end 78c electrically joined to the first input terminal 62a of the voltage controller 46. A second insertion hole 80 having a substantially perfect circular shape is formed at the one end 78a of the second bus bar 66. The second insertion hole 80 is connected to the first insertion hole 76.

The length of the first insertion hole 76 in the long axis direction (length in the vehicle front/rear direction) is larger than the diameter of the second insertion hole 80. For example, the length of the first insertion hole 76 in the long axis direction is twice to four times larger than the length of the first insertion hole 76 in the short axis direction. It should be noted that the length of the first insertion hole 76 in the long axis direction can be determined as necessary. A bent portion 82 which is bent downward at substantially 90° is provided in the second extension 78b. The angle of the bent portion 82 can be determined as necessary.

The joint portion 70 includes a bolt 84 extending in an upper/lower direction, and a nut 86 screwed with a shaft portion 84a of the bolt 84. The shaft portion 84a of the bolt 84 is inserted into the first insertion hole 76 and the second insertion hole 80. Specifically, in the normal state, the shaft portion 84a of the bolt 84 is positioned on the vehicle rearmost side of the first insertion hole 76 (the other end side of the first bus bar 64). That is, in the state where the first bus bar 64 and the second bus bar 66 are electrically connected together, the joint portion 70 can be displaced together with the second bus bar 66 toward the vehicle front side (where the contactor 52 is positioned) relative to the first bus bar 64.

As described above, a displacement absorption structure 88 (the non-straight portion 72 and the first insertion hole 76), which enables the voltage controller 46 and the contactor 52 to be displaced closer to each other in the direction in which the fuel cell stack 20 and the voltage controller 46 are arranged, is formed in the bus bar 68.

In the bus bar 68, the first insertion hole 76 may have a substantially perfect circular shape, and the displacement absorption structure 88 may be made up of only the non-straight portion 72. Further, the bus bar 68 may not be provided with the non-straight portion 72. The displacement absorption structure 88 may be made up of only the first insertion hole 76 in the form of the long hole. The non-straight portion 72 may not be provided in the first bus bar 64, but may be provided in the second bus bar 66. Alternatively, the non-straight portion 72 may be provided in both of the first bus bar 64 and the second bus bar 66.

The fourth power line 56d has the same structure as the third power line 56c. Therefore, description of the detailed structure of the fourth power line 56d is omitted.

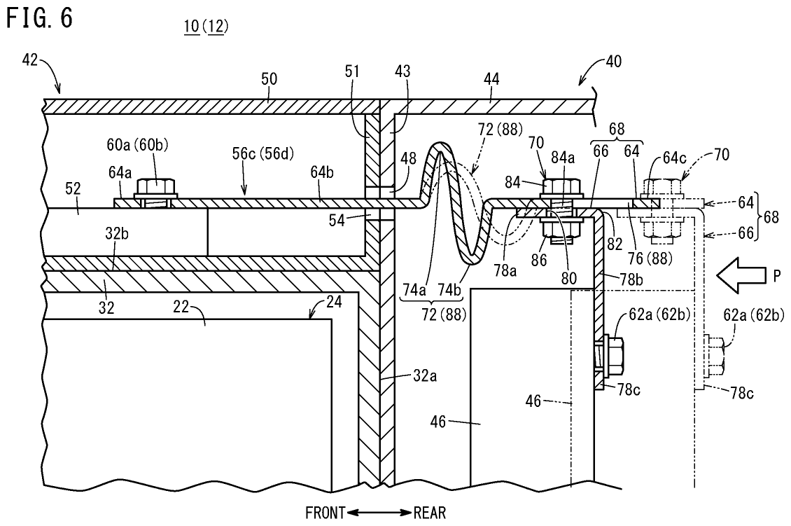

In this regard, for example, in the case where impact is applied to the fuel cell vehicle 12 in the vehicle front/rear direction, the external load P (impact load) in the direction from the voltage controller 46 to the fuel cell stack 20 (toward the vehicle front side) may be applied to the voltage controller 46, as shown in FIG. 6. In this case, the joint portion 70 of the third power line 56c and the fourth power line 56d slides in the first insertion hole 76 toward the vehicle front side. Therefore, the second bus bar 66 is displaced together with the voltage controller 46 toward the vehicle front side relative to the contactor 52.

Then, when the joint portion 70 moves to the end of the first insertion hole 76 on the vehicle front side, the external load P toward the vehicle front side is applied from the joint portion 70 to the first bus bar 64. As a result, the non-straight portion 72 is elastically deformed in the vehicle front/rear direction. Specifically, the first curved portion 74a and the second curved portion 74b are curved in a manner that the length L1 of the first curved portion 74a and the length L2 of the second curved portion 74b become small, respectively. As a result, the second bus bar 66 is displaced together with the voltage controller 46 further toward the vehicle front side, relative to the contactor 52. Therefore, it is possible to reduce application of the external load P from the bus bar 68 to the contactor 52.

In this case, the fuel cell vehicle 12 according to the embodiment of the present invention offers the following advantages.

In the fuel cell system 10, the bus bar 68 is provided with the displacement absorption structure 88 which enables the voltage controller 46 and the contactor 52 to be displaced closer to each other in the direction in which the fuel cell stack 20 and the voltage controller 46 are arranged.

In the structure, even if the external load P is applied to the voltage controller 46, since the voltage controller 46 and the contactor 52 are displaced closer to each other by the displacement absorption structure 88 of the bus bar 68, it is possible to reduce application of the external load P from the bus bar 68 to the contactor 52.

The first bus bar 64 is provided with the non-straight portion 72 which is elastically deformable in the direction in which the fuel cell stack 20 and the voltage controller 46 are arranged.

In the structure, it is possible to easily deform the first bus bar 64 by the non-straight portion 72.

The first bus bar 64 includes the first extension 64b extending in the direction in which the fuel cell stack 20 and the voltage controller 46 are arranged, and the first extension 64b is provided with the non-straight portion 72.

In the structure, it is possible to elastically deform the non-straight portion 72 effectively.

The non-straight portion 72 includes a portion having a circular arc shape.

In the structure, it is possible to elastically deform the non-straight portion 72 more effectively.

The non-straight portion 72 includes the first curved portion 74a curved toward one surface of the first extension 64b (upward), and the second curved portion 74b curved toward the other surface of the first extension 64b (downward). The first curved portion 74a and the second curved portion 74b are continuous with each other.

In the structure, it is possible to elastically deform the non-straight portion 72 even more effectively.

Each of the first curved portion 74a and the second curved portion 74b has a circular arc shape.

In the structure, it is possible to elastically deform the first curved portion 74a and the second curved portion 74b effectively.

The length L1 of the first curved portion 74a in the direction in which the fuel cell stack 20 and the voltage controller 46 are arranged is the same as the length L2 of the second curved portion 74b in this arrangement direction.

In the structure, it is possible to elastically deform the first curved portion 74a and the second curved portion 74b with good balance.

The first bus bar 64 and the second bus bar 66 are joined together using the bolt 84 inserted into the first insertion hole 76 and the second insertion hole 80. The first insertion hole 76 is a long hole extending in the direction in which the fuel cell stack 20 and the voltage controller 46 are arranged. The bolt 84 is movable in the first insertion hole 76 in this arrangement direction.

In the structure, in the case where the external load P is applied to the voltage controller 46, the bolt 84 moves together with the second bus bar 66 in the first insertion hole 76 toward the contactor 52. Therefore, since the voltage controller 46 can be displaced toward the contactor 52, it is possible to effectively reduce application of the external load P from the bus bar 68 to the contactor 52.

The present invention is not limited to have the above structure. The first curved portion 74a and the second curved portion 74b may be provided in plurality, respectively. In this case, the first curved portions 74a and the second curved portions 74b may be provided alternately. Only the first curved portions 74a or the second curved portions 74b may be provided continuously, or both of the first curved portions 74a and the second curved portions 74b may be provided continuously. The voltage control unit 40 may be provided on the vehicle front side of the fuel cell stack 20.

### First Modified Embodiment

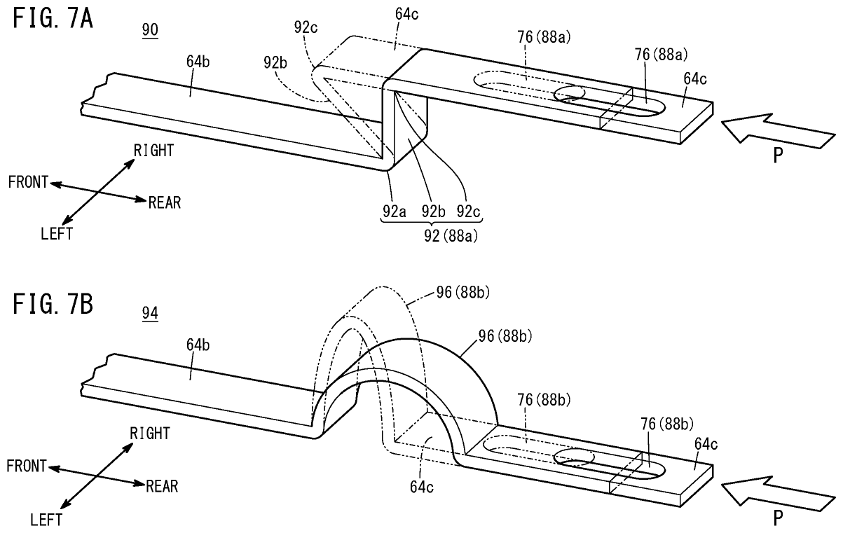

Next, a first bus bar 90 according to a first modified embodiment will be described with reference to FIG. 7A. In the first bus bar 90 according to the modified embodiment, the constituent components having the same structure as those of the above-described first bus bar 64 are labeled with the same reference numeral, and description thereof is omitted. This applies to a later-described first bus bar 94 according to a second modified embodiment.

As shown in FIG. 7A, the first extension 64b of the first bus bar 90 according to the first modified embodiment is provided with a non-straight portion 92. The non-straight portion 92 includes a first bent portion 92a bent upward from a position in the middle of the first extension 64b, an extension 92b extending straight upward from the first bent portion 92a, and a second bent portion 92c bent from an extension end of the extension 92b toward the vehicle rear side of the first bus bar 90.

In the normal state, each of the first bent portion 92a and the second bent portion 92c has an angle of substantially 90°. It should be noted that the angles of the first bent portion 92a and the second bent portion 92c may be determined as necessary, and may be blunt angles or sharp angles. Further, the angles of the first bent portion 92a and the second bent portion 92c may be different from each other.

A displacement absorption structure 88a (the non-straight portion 92 and the first insertion hole 76), which enables the voltage controller 46 and the contactor 52 to be displaced closer to each other in the direction in which the fuel cell stack 20 and the voltage controller 46 are arranged, is formed in the first bus bar 90.

In the modified embodiment, when the external load P is applied, the non-straight portion 92 is elastically deformed in a manner that the other end 64c of the first bus bar 90 is displaced toward the first extension 64b. In the structure, the first bus bar 90 offers the same advantages as in the case of the first bus bar 64.

In the modified embodiment, the extension 92b may extend upward from the first bent portion 92a in a curved shape. The first bent portion 92a may be bent downward from a position in the middle of the first extension 64b, and the extension 92b may extend downward in a straight shape or in a curved shape from the first bent portion 92a. In the first bus bar 90, the first insertion hole 76 may be formed to have a substantially perfect circular shape, and the displacement absorption structure 88a may be made up of only the non-straight portion 92. The non-straight portion 92 may not be provided in the first bus bar 90, but may be provided in the second bus bar 66. Alternatively, the non-straight portion 92 may be provided in both of the first bus bar 90 and the second bus bar 66.

### Second Modified Embodiment

As shown in FIG. 7B, the first extension 64b of the first bus bar 94 according to the second modified embodiment is provided with a non-straight portion 96. The non-straight portion 96 has a circular arc shape (e.g., semicircular shape), and is curved to protrude toward one surface of the first extension 64b (upward).

The first bus bar 94 is provided with a displacement absorption structure 88b (the non-straight portion 96 and the first insertion hole 76) which enables the voltage controller 46 and the contactor 52 to be displaced closer to each other in the direction in which the fuel cell stack 20 and the voltage controller 46 are arranged.

The structure offers the same advantages as in the case of the first bus bar 64 described above.

In the modified embodiment, the non-straight portion 96 may be curved to protrude toward the other surface of the first extension 64b (downward).

In the first bus bar 94, the first insertion hole 76 may be formed to have a substantially perfect circular shape, and the displacement absorption structure 88b may be made up of only the non-straight portion 96. The non-straight portion 96 may not be provided in the first bus bar 94, but may be provided in the second bus bar 66. Alternatively, the non-straight portion 96 may be provided in both of the first bus bar 94 and the second bus bar 66.

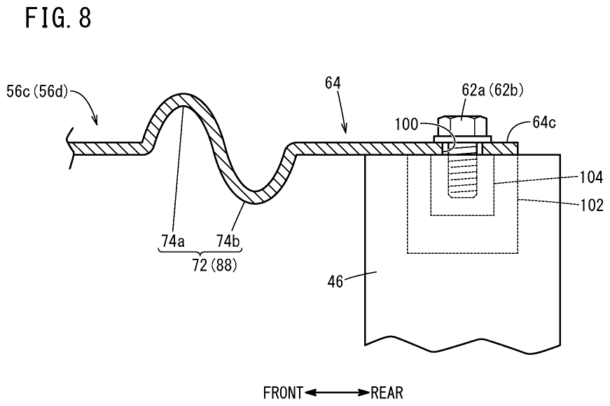

As shown in FIG. 8, in the present invention, each of the third power line 56c and the fourth power line 56d may include the first bus bar 64, and the second bus bar 66 may be dispensed with. In this case, the other end 64c of the first bus bar 64 is electrically and directly connected to the first input terminal 62a (second input terminal 62b) of the voltage controller 46.

The first input terminal 62a (second input terminal 62b) is inserted into a hole 100 formed in the other end 64c of the first bus bar 64. The first input terminal 62a (second input terminal 62b) presses the other end 64c of the first bus bar 64 against a bus bar 104 provided in a terminal block 102. The terminal block 102 is made of electrically insulating material such as resin. The bus bar 104 has a circular column shape or a prism shape (e.g., quadrangular column shape). The first input terminal 62a can be screwed with the bus bar 104.

In the present invention, instead of the first bus bar 64 shown in FIG. 8, the first bus bar 90 or the first bus bar 94 may be provided, and the other end 64c of each of the first bus bars 90, 94 may be electrically and directly connected to the first input terminal 62a (second input terminal 62b) of the voltage controller 46.

The present invention is not limited to the above-described embodiments. Various modifications may be made without departing from the gist of the present invention.

The above embodiments are summarized as follows:

The above embodiments disclose the fuel cell system (10) in which the first electrical equipment auxiliary device (46) provided on the lateral side of the fuel cell stack (20) and the second electrical equipment auxiliary device (52) provided above the fuel cell stack are electrically connected together by the bus bar (68) in the form of the flat plate. The bus bar is provided with the displacement absorption structure (88, 88a, 88b) which enables the first electrical equipment auxiliary device and the second electrical equipment auxiliary device to be displaced closer to each other in the direction in which the fuel cell stack and the first electrical equipment auxiliary device are arranged.

In the fuel cell system, the bus bar may be provided with the non-straight portion (72, 92, 96) which is elastically deformable in the direction in which the fuel cell stack and the first electrical equipment auxiliary device are arranged.

In the fuel cell system, the bus bar may include the extension (64b) extending in the direction in which the fuel cell stack and the first electrical equipment auxiliary device are arranged, and the non-straight portion may be provided in the extension.

In the fuel cell system, the non-straight portion may include a portion having a circular arc shape.

In the fuel cell system, the non-straight portion may include the first curved portion (74a) curved toward one surface of the extension and the second curved portion (74b) curved toward the other surface of the extension, and the first curved portion and the second curved portion may be continuous with each other.

Each of the first curved portion and the second curved portion may have a circular arc shape.

The length (L1) of the first curved portion in the direction in which the fuel cell stack and the first electrical equipment auxiliary device are arranged may be the same as the length (L2) of the second curved portion in the direction in which the fuel cell stack and the first electrical equipment auxiliary device are arranged.

In the fuel cell system, the bus bar may include the first bus bar (64, 90, 94) provided on the second electrical equipment auxiliary device side and including the first insertion hole (76), and the second bus bar (66) provided on the first electrical equipment auxiliary device side and including the second insertion hole (80), and the first bus bar and the second bus bar may be joined together using the bolt (84) inserted into the first insertion hole and the second insertion hole, at least one of the first insertion hole and the second insertion hole may be a long hole extending in the direction in which the fuel cell stack and the first electrical equipment auxiliary device are arranged, and the bolt may be movable in the long hole in the direction in which the fuel cell stack and the first electrical equipment auxiliary device are arranged.

What is claimed is:

1. A fuel cell system in which a first electrical equipment auxiliary device provided on a lateral side of a fuel cell stack and a second electrical equipment auxiliary device provided above the fuel cell stack are electrically connected together by a bus bar in a form of a flat plate, wherein
the bus bar is provided with a displacement absorption structure which enables the first electrical equipment auxiliary device and the second electrical equipment auxiliary device to be displaced closer to each other in a direction in which the fuel cell stack and the first electrical equipment auxiliary device are arranged.

2. The fuel cell system according to claim 1, wherein the bus bar is provided with a non-straight portion which is elastically deformable in the direction in which the fuel cell stack and the first electrical equipment auxiliary device are arranged.

3. The fuel cell system according to claim 2, wherein
the bus bar includes an extension extending in the direction in which the fuel cell stack and the first electrical equipment auxiliary device are arranged, and
the non-straight portion is provided in the extension.

4. The fuel cell system according to claim 3, wherein the non-straight portion includes a portion having a circular arc shape.

5. The fuel cell system according to claim 4, wherein the non-straight portion includes:
a first curved portion curved toward one surface of the extension; and
a second curved portion curved toward another surface of the extension, and
the first curved portion and the second curved portion are continuous with each other.

6. The fuel cell system according to claim 5, wherein each of the first curved portion and the second curved portion has a circular arc shape.

7. The fuel cell system according to claim 5, wherein a length of the first curved portion in the direction in which the fuel cell stack and the first electrical equipment auxiliary device are arranged is identical to a length of the second curved portion in the direction in which the fuel cell stack and the first electrical equipment auxiliary device are arranged.

8. The fuel cell system according to claim 1, wherein the bus bar includes:
a first bus bar provided on the second electrical equipment auxiliary device side and including a first insertion hole; and
a second bus bar provided on the first electrical equipment auxiliary device side and including a second insertion hole,
the first bus bar and the second bus bar are joined together using a bolt inserted into the first insertion hole and the second insertion hole,
at least one of the first insertion hole and the second insertion hole is a long hole extending in the direction in which the fuel cell stack and the first electrical equipment auxiliary device are arranged, and
the bolt is movable in the long hole in the direction in which the fuel cell stack and the first electrical equipment auxiliary device are arranged.
